(19) United States
(12) Patent Application Publication
(10) Pub. No.: US 2017/0285886 A1
(43) Pub. Date: Oct. 5, 2017

(54) Creating, Updating, Sharing, Managing, and Monitoring a Plurality of Independent Interactive System Productivity Facility (ISPF) Windows

(71) Applicant: CA, Inc., New York, NY (US)

(72) Inventors: Kristian Klima, Prague 9 (CZ); Robert Skorpil, Dobrejovice (CZ)

(21) Appl. No.: 15/087,311

(22) Filed: Mar. 31, 2016

(51) Int. Cl. G06F 3/0482; H04L 12/26; H04L 12/24

(52) U.S. Cl. CPC G06F 3/0482; H04L 41/22; H04L 43/14

(57) ABSTRACT

A user terminal executes a control application that generates and outputs a plurality of windows to a user terminal within a single emulator session and under a single user login. Each window corresponds to a particular application executing at the mainframe, and is sizable and immovable relative to the other windows. The control application translates application-independent commands into application-specific commands for the applications, and outputs those application-specific commands to those applications.

### BACKGROUND

The present disclosure relates to mainframe computing systems, and more particularly to create, clone, share, update, and manage multiple independent Interactive System Productivity Facility (ISPF) panels in independent windows.

Mainframe computers, or “mainframes,” are large, complex computing systems primarily used by large corporate entities to execute various enterprise applications. Such applications include, but are not limited to, critical applications related to bulk data processing, process control, hosting, ecommerce, software development and/or testing, planning, and finance.

Users typically interact with applications executing on the mainframe computer using a software application known in the art as the Interactive System Productivity Facility (ISPF). As is known in the art, ISPF is a software application for the z/OS operating system that provides a user interface for the applications executing on the mainframe computer. ISPF presents the user interfaces at a client user terminal as panels, with each ISPF panel allowing users to interface with a corresponding different application. Such applications include, for example, a browser for viewing sets of data, an editor for modifying the data in the data sets, and a variety of utility applications for searching and managing data. Additionally, ISPF panels also provide certain functions with which a user can manage the applications executing on the mainframe computer.

### BRIEF SUMMARY

The present disclosure provides a computer-implemented method, a user terminal, and a corresponding computer-readable storage medium for creating, cloning, sharing, updating, and managing multiple independent Interactive System Productivity Facility (ISPF) panels in independent windows at the user terminal. In one embodiment, a computer-implemented method first establishes a text-based terminal session with a mainframe computer via a computer network. The text-based terminal session is associated with a single user login. The computer-implemented method also outputs a plurality of windows to the user terminal, with each window comprising a graphical user interface (GUI) for a corresponding software application executing on the mainframe computer. In this embodiment, each of the plurality of windows is sizable and movable independently of the other windows. The method then calls for the user terminal receiving a command. The command directs a first application executing on the mainframe computer to perform an action. Then, the command is translated to an application-specific command for a second application executing on the mainframe computer. The second application is associated with a second window that does not have focus. The method then outputs the application-specific command to the second application while maintaining the focus at the first window.

In another embodiment, the present disclosure provides a user terminal comprising a communications interface circuit and a processing circuit. The communications interface circuit is configured to communicate data with a mainframe computer via a text-based terminal session. The processing circuit is operatively connected to the communications network and is configured to generate a plurality of Interactive System Productivity Facility (ISPF) windows. Each ISPF window is independently sizable and movable relative to the other ISPF windows, and corresponds to a software application executing on the mainframe computer. The processing circuit is also configured to output the plurality of ISPF windows to a single emulator instance executing at the user terminal, translate a command to an application-specific command for a second application associated with a second ISPF window, wherein the first ISPF window has focus and the second ISPF window lacks focus, and then output the application-specific command to the second application while maintaining the focus at the first window.

In another embodiment, the present disclosure provides a computer-readable storage medium. The computer-readable storage medium has computer code stored thereon that, when executed by a processing circuit of a user terminal communicatively connected to a mainframe computer via a text-based session, causes the processing circuit to establish a text-based terminal session with a mainframe computer via a computer network, output a plurality of windows to the user terminal, wherein each window comprises a graphical user interface (GUI) for a corresponding software application executing on the mainframe computer, and is sizable and movable independently of the other windows, receive a command directing a first application executing on the mainframe computer to perform an action, translate the command to an application-specific command for a second application executing on the mainframe computer, wherein the second application is associated with a second window that does not have focus, and output the application-specific command to the second application while maintaining focus at the first window.

Of course, those skilled in the art will appreciate that the present embodiments are not limited to the above contexts or examples, and will recognize additional features and advantages upon reading the following detailed description and upon viewing the accompanying drawings.

### BRIEF DESCRIPTION OF THE DRAWINGS

Aspects of the present disclosure are illustrated by way of example and are not limited by the accompanying figures with like references indicating like elements.

FIG. 1 is a block diagram illustrating a text-based terminal session established between a client-side user terminal and a mainframe computer via a computer network, according to embodiments of the present disclosure.

FIGS. 2A-3 illustrate different ISPF panels. Specifically:

FIG. 2A illustrates a Time Sharing Option (TSO) Logon screen for allowing a user to logon to a mainframe computer and execute ISPF.

FIG. 2B illustrates an Interactive Storage Management Facility (ISMF) primary option screen for allowing a user to manage system storage.

FIG. 2C illustrates a menu for a Program Development Products screen that allows users to access and interact with a variety of mainframe-based utilities.

FIG. 3 illustrates a split-screen panel containing both a Program Development Products screen and an ISMF primary option screen.

FIG. 4 illustrates a pair of ISPF panels associated with an ISMF primary option screen and a Program Development Products screen, respectively, with each ISPF panel being output as an independent window according to embodiments of the present disclosure.

FIGS. 5A-5B illustrate that each independent window comprising an ISPF panel is both independently sizable (FIG. 5A) and independently movable (FIG. 5B) according to embodiments of the present disclosure.

FIGS. 6A-6B illustrate independent windows comprising respective ISPF panels upon receiving an application-independent command to refresh the ISPF panels in each window (FIG. 6A), and an application-independent command to switch focus between windows (FIG. 6B) according to embodiments of the present disclosure.

FIG. 7 illustrates a plurality of independently movable and sizable windows with each independent window being associated with a different ISPF panel, and output to a single instance of an emulator at a user terminal according to embodiments of the present disclosure.

FIG. 8 illustrates a plurality of independently movable and sizable windows with each independent window being associated with a different ISPF panel, and with one of the windows being cloned from another window according to embodiments of the present disclosure.

FIG. 9 is a flow diagram illustrating a method performed at a client-side user terminal for managing independently movable and sizable windows comprising respective ISPF panels according to embodiments of the present disclosure.

FIGS. 10A-10C are flow diagrams illustrating methods performed at a client-side user terminal for refreshing the independent windows at the user terminal (FIG. 10A), for switching focus between the independent windows (FIG. 10B), and for cloning a selected one of the independent windows (FIG. 10C), according to embodiments of the present disclosure. In FIGS. 10A-10C, each window comprises a respective ISPF panel associated with a corresponding application executing at the mainframe computer.

FIG. 11 is a block diagram illustrating a user terminal configured according to embodiments of the present disclosure.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely as hardware, entirely as software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device (e.g., magnetic tape), or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

Accordingly, the present disclosure provides a user terminal, a method implemented at the user terminal, and a corresponding computer-readable storage medium for facilitating a user's interaction with a plurality of distinct software applications executing at a mainframe computer. More particularly, a user is able to create, organize, clone, share, update, and manage multiple ISPF panels as independent windows under a single user login and across multiple user terminals.

In more detail, a single text-based terminal session, such as a Telnet session, for example, is established between a client-side user terminal and a mainframe computer. The user will log onto the mainframe computer and execute the ISPF software application executing at the mainframe computer. However, rather than output up to two ISPF panels in a “split-screen” configuration to a single emulator instance at the user terminal, embodiments of the present disclosure configure the user terminal to output a plurality of independent windows to the single emulator instance. Each independent window is associated with one of a plurality of application programs executing at the mainframe computer, and comprises the contents of a respective ISPF panel associated with that application program. Thus, each such window output to the user terminal, or to any other device, is referred to herein as an “ISPF window.”

According to embodiments of the present disclosure, each ISPF window is independently sizable and movable relative to the other ISPF windows, and can receive, and send, commands intended for any of the applications associated with any of the other ISPF windows. Such commands include, but are not limited to, a refresh command which refreshes the ISPF panel content in one or more selected ISPF windows, a switch-focus command which allows a user to easily switch the focus from a first ISPF window to a second ISPF window, and a clone command which clones a selected one of the ISPF windows such that the output of the application program associated with the selected ISPF window is also output to the cloned ISPF window. Additionally, embodiments of the present disclosure do not limit outputting the ISPF windows to any particular user terminal. In some embodiments of the present disclosure, a selected ISPF window may be output to a different specified device in addition to, or in lieu of, being output to the user terminal.

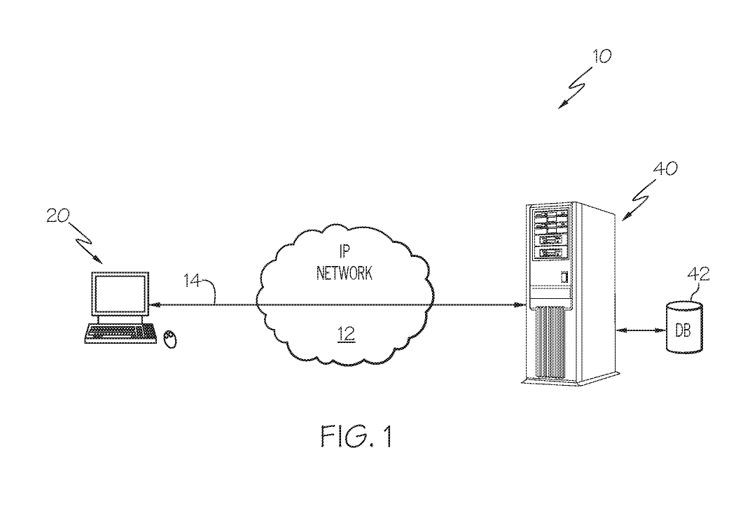

Turning now to the drawings, FIG. 1 is a block diagram illustrating a communications system 10 configured according to an embodiment of the present disclosure. As seen in FIG. 1, system 10 comprises an IP network 12 that communicatively interconnects a client-side user terminal 20 (“terminal 20”) with a mainframe computer 40 (“mainframe” 40) and a mass storage device 42. As those of ordinary skill in the art will readily appreciate, the various components depicted in FIG. 1 are illustrative only. Other network-based and/or client-side components and entities may be present in or connected to system 10, even though those components are not specifically illustrated or discussed herein. Such components include, for example, additional user terminals (not shown) that connect to the mainframe 40 either directly or via network 12, as well as various routers, gateways, access nodes, switches, and the like.

Network 12 may comprise any private and/or public IP network known in the art, but is configured to communicate data between the terminal 20 and the mainframe 40 in data packets. By way of example only, network 12 may comprise a private ETHERNET network, the Internet, or both, and may comprise the various servers, routers, gateways, and other such entities to facilitate the communication of data packets over network 12.

Mainframe 40 is a computing device that may, for example, be associated with, and used primarily by, a large company or corporation. As is known in the art, such as mainframes are very powerful, highly reliable, and stable devices. Thus, mainframe 40 seen in FIG. 1 may specifically be designed to perform functions such as execute critical application programs, and collect, store, maintain, and process bulk data, for example. To facilitate the requisite data storage functions, mainframe 40 may be communicatively connected to a mass storage device 42, as is known in the art.

Terminal 20 may comprise, by way of example only, any terminal device or personal computing device that is known in the art. Thus, although FIG. 1 illustrates terminal 20 as a personal desktop computer, this is for illustrative purposes only. Those of ordinary skill in the art will readily appreciate that terminal 20 may comprise a laptop computer, notebook computer, a tablet computer, or any other type of computing device so long as it is capable of communicating data with mainframe 40 via a text-based communication session 14 via IP network 12.

As explained in more detail below, terminal 20 is configured to execute a single instance of an emulator program that allows a user to interact with a plurality of application programs executing on the mainframe 40. The user interfaces for each of the plurality of application programs is output as an ISPF panel. As described above, conventional terminals are only configured to output a limited number of ISPF panels to the single emulator instance, and further, only in a “split-screen” configuration. So displayed, the user cannot alter the size or location of an ISPF panel on a display screen of a terminal. However, a terminal 20 configured according to the present embodiments outputs each of the ISPF panels as an independent ISPF window that is independently sizable and movable.

Further, embodiments of the present disclosure map pre-defined “application-independent” commands to “hot-keys,” for example. Such commands include, but are not limited to, REFRESH, SWITCH FOCUS, CLONE WINDOW, and CLOSE. Whenever a user depresses a given “hot-key,” (e.g., the F7 key or a combination of multiple keys), embodiments of the present disclosure translate the corresponding “application-independent” command into corresponding application-specific commands, and outputs those commands to one or more selected application programs associated with other ISPF windows. According to the present disclosure, the function or action associated with the hot-key is performed at each of the ISPF windows, regardless of whether a given ISPF window currently has, or does not have, focus.

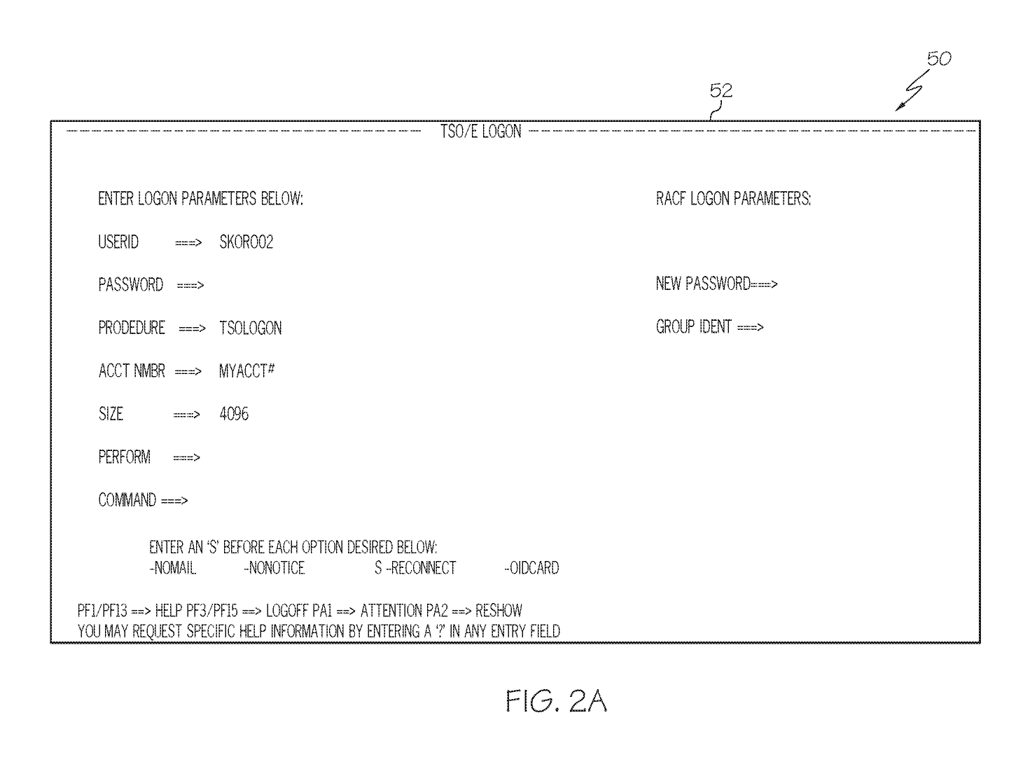

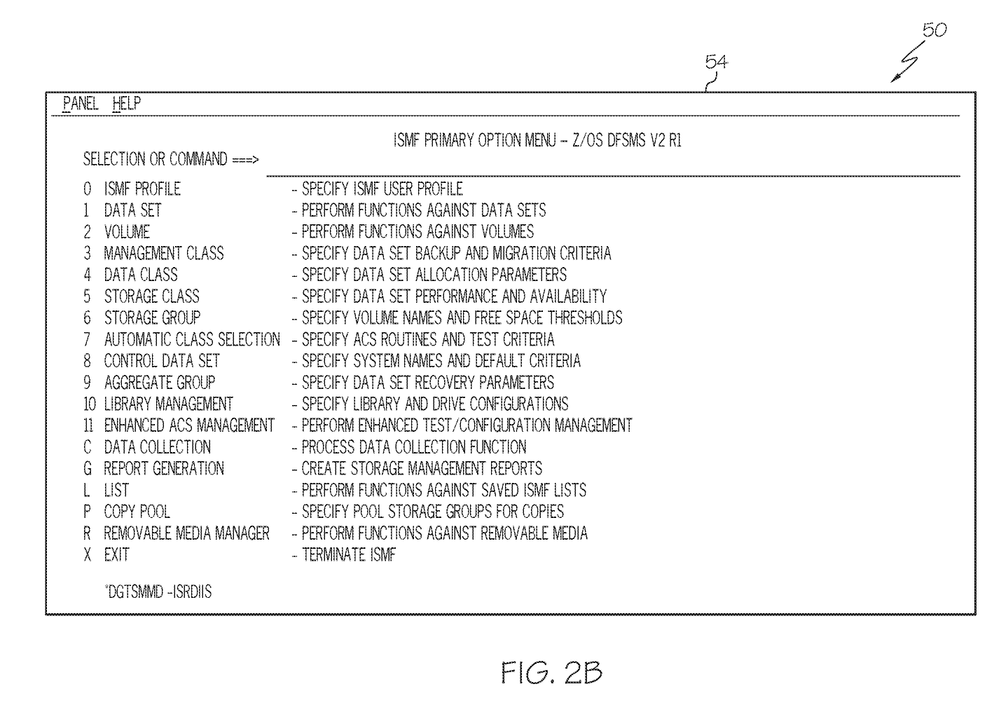

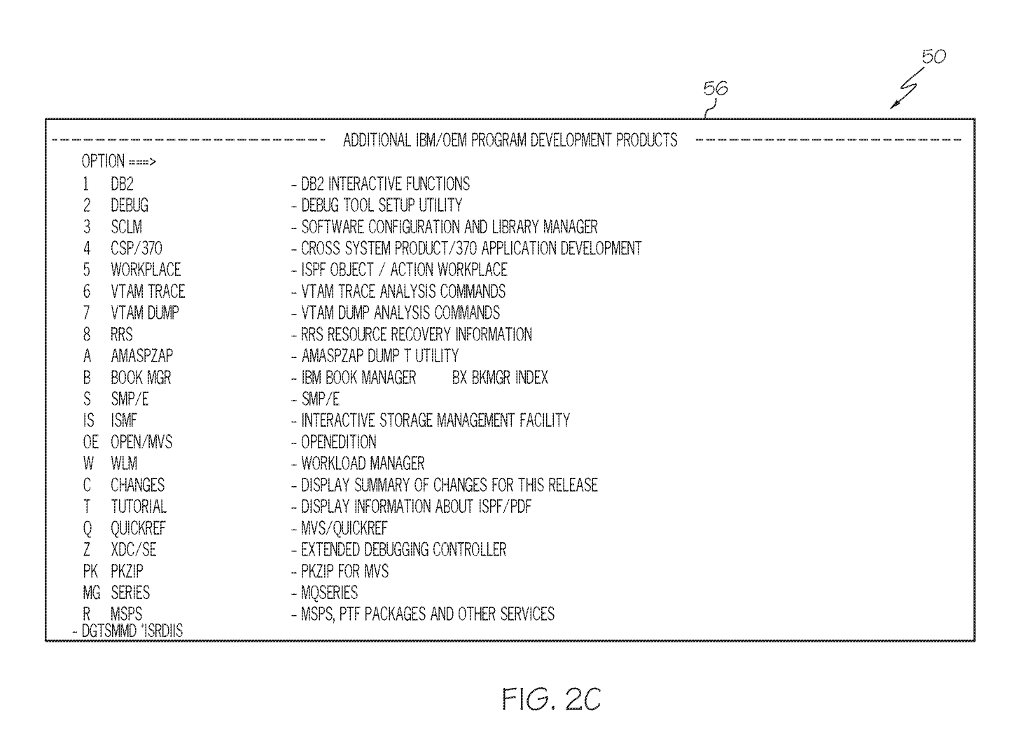

FIGS. 2A-2C illustrate an emulator instance 50 (“emulator 50”) that a user might employ to interact with the mainframe 40. Specifically, the user would first control the terminal 20 to establish a text-based communication session 14 with the mainframe 40. The manner for establishing such a text-based session (e.g., a Telnet session) is well-known in the art, and thus, not described in detail here. It is sufficient to clarify, however, that the user would instantiate a single emulator 50, and that data would be communicated to and from the mainframe 40 via the single text-based communications session 14. Once the text-based session is established, the user could logon to the mainframe 40 by inputting the user's particular username/password combination into the logon screen 52 (FIG. 2A).

Provided the user logon process is successfully, the user would then instantiate the ISPF application executing at the mainframe 40. As previously described, the ISPF application facilitates the user's ability to interact with, and control the functions of, a plurality of application programs and utilities executing at the mainframe 40. As seen in FIG. 2B, the user would be presented with an ISPF primary option menu panel 54. Using this ISPF panel 54, the user can instantiate the execution of selected application programs at the mainframe 40, or access the menu of another already-executing application program at mainframe 40.

For example, the user at terminal 20 may access one of the various tools and utilities supported by the z/OS operating system of mainframe 40 simply by inputting one of the displayed options (e.g., ‘0’, ‘1’, ‘2’, ‘3’, . . . ‘X’) into a command input area of the ISPF panel 54. Once the command is processed, the emulator 50 would then change from displaying the ISPF panel 54 to the user to displaying a different ISPF panel to the user, such as ISPF panel 56 seen in FIG. 2C. Thus, with such methods, the user may have the ability to execute multiple application programs on the mainframe 40, but only has the ability to view whichever ISPF panel corresponds to the current application program.

Such methods of allowing the user to view only one ISPF panel at a time are restrictive. Particularly, the user can only interface with a single application at a time, and is required to constantly switch between ISPF panels 54, 56 to interact with a different, corresponding application program. Such switching between ISPF panels 54, 56 can become burdensome for a user who wishes to monitor the output of several applications simultaneously.

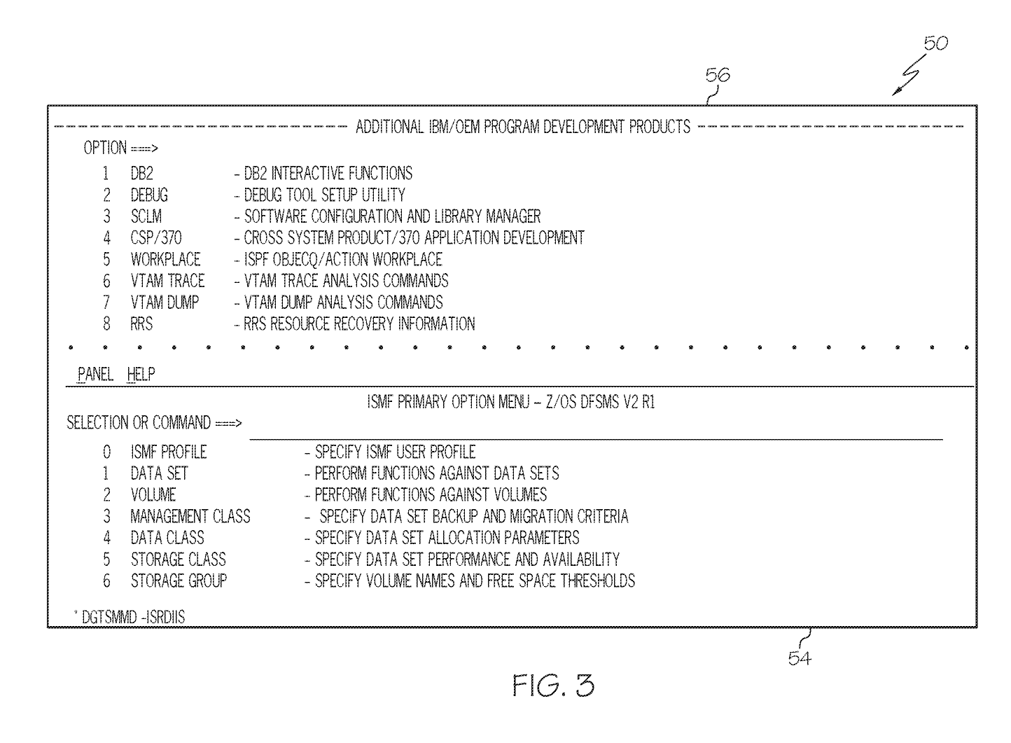

In some versions of ISPF, though, a user is permitted to open two ISPF panels in emulator 50 as a single, “split-screen” ISPF panel. Specifically, as seen in FIG. 3, one ISPF panel 54 appears in the lower half of the split-screen, while the ISPF panel 56 appears in the top half of the split-screen. The user is able to view the contents of both ISPF panels 54, 56, but is not able to independently control the size or the position of either portion of the split-screen ISPF panel. Nor is the user able to control an application or ISPF panel from any other ISPF panel. Thus, to interact with any given program, the user must switch between panels to give the ISPF panel associated with the particular application program the focus.

In some cases, more than two ISPF panels may be output to the user in a further split-screen (e.g., an ISPF panel split into three or more equivalent portions). However, with a fixed screen size, the number of ISPF panels that can be practically output to the user is severely limited. Moreover, “stuffing” additional ISPF panels into a split-screen ISPF panel does not make interacting with the corresponding application programs any easier for the user. Rather, such divisions make interacting with the application programs executing on the mainframe 40 more difficult for the user.

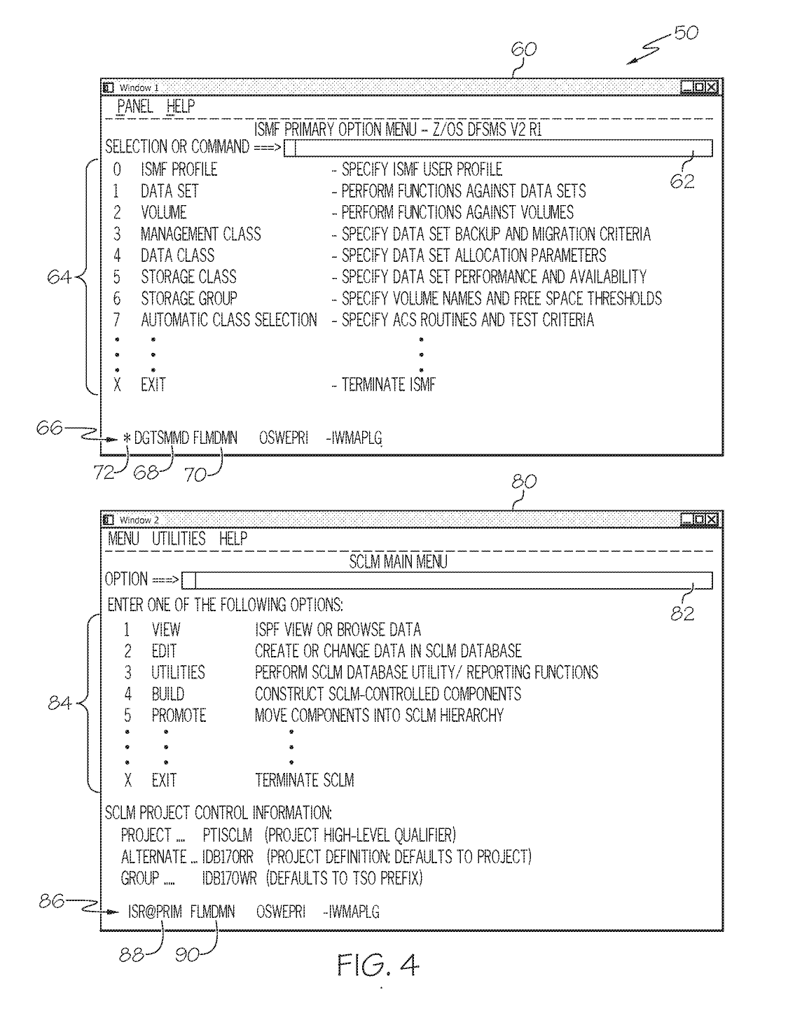

Embodiments of the present invention, however, output each different ISPF panel as its own independent ISPF window within the same emulator 50. For example, as seen in FIG. 4, emulator 50 comprises two ISPF windows 60 and 80, although as seen later in more detail, more than two ISPF windows are easily handled by the present embodiments. Each ISPF window 60, 80 comprises the contents of a respective ISPF panel associated with a corresponding application program executing on mainframe 40. For example, ISPF window 60 comprises the contents of the ISPF panel associated with the ISMF Primary Option Menu for z/OS, while ISPF window 80 comprises the contents of the ISPF panel associated with the Software Configuration and Library Manager (SCLM) facility for z/OS.

As seen in FIG. 4, each ISPF window 60, 80 comprises, respectively, a command entry field 62, 82, a list of valid commands and options 64, 84, that the user may enter into the respective command entry field 62, 82, and an application status line 66, 86, that identifies the different application programs executing on mainframe 40, and that are associated with the visible ISPF windows 60, 80 currently being output to the user terminal 20. In this embodiment, the application status line 66, 86 for each ISPF window 60, 80 comprises two application identifiers 68, 70 and 88, 90. Identifier 68 in ISPF window 60 identifies ISPF window 60 and its corresponding application executing on the mainframe 40. Identifier 70 of ISPF window 60 identifies ISPF window 80 and its corresponding application program executing on mainframe 40. Similarly, identifier 88 in ISPF window 80 identifies ISPF window 80 and the corresponding application executing on the mainframe 40, while identifier 90 identifies ISPF window 60 and its corresponding application program executing on mainframe 40.

In addition to the identifiers, each of the application status lines 66, 86 displays a focus indicator 72, 92 that identifies which of the ISPF windows 60, 80 currently has focus. As the focus moves between ISPF windows 60, 80, in a process that is described in more detail later, the indicators 72, 92 will move from identifier to identifier to indicate which ISPF window 60, 80 has received the focus. Additionally, in one or more embodiments of the present disclosure, a control application executing at the terminal 20 can determine from an analysis of the indicators 72, 92 and the identifiers 68, 70, 88, 90, which ISPF window 60, 80 currently has focus. So determined, the control application is able to route data received from an application executing on mainframe 40 to the currently active window.

As seen in FIG. 4, each ISPF window 60, 80 is generated to have a similar “look-and-feel” as a window generated by MICROSOFT WINDOWS. This breeds familiarity with the functions provided by each ISPF window 60, 80. For example, each ISPF window 60, 80 functions independently of all other ISPF windows 60, 80 in emulator 50. Thus, using the familiar “window-type” controls in the upper right hand corner of each ISPF window 60, 80, a user is able to minimize each ISPF window 60, 80 to, for example, a tool bar, maximize the size of each ISPF window 60, 80, and close each ISPF window 60, 80. However, differently from the “split-screen” approach, the minimize, maximize, and close functions of these windows-type controls operates only the corresponding ISPF window 60 or ISPF 80. Those commands do not affect any of the other ISPF windows 60, 80.

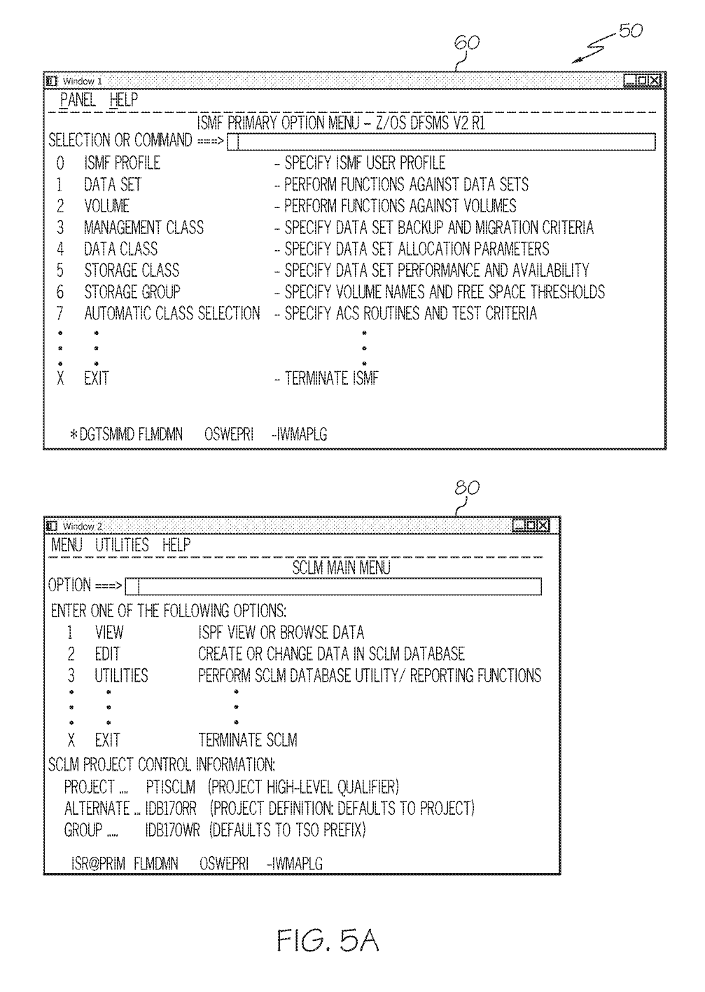

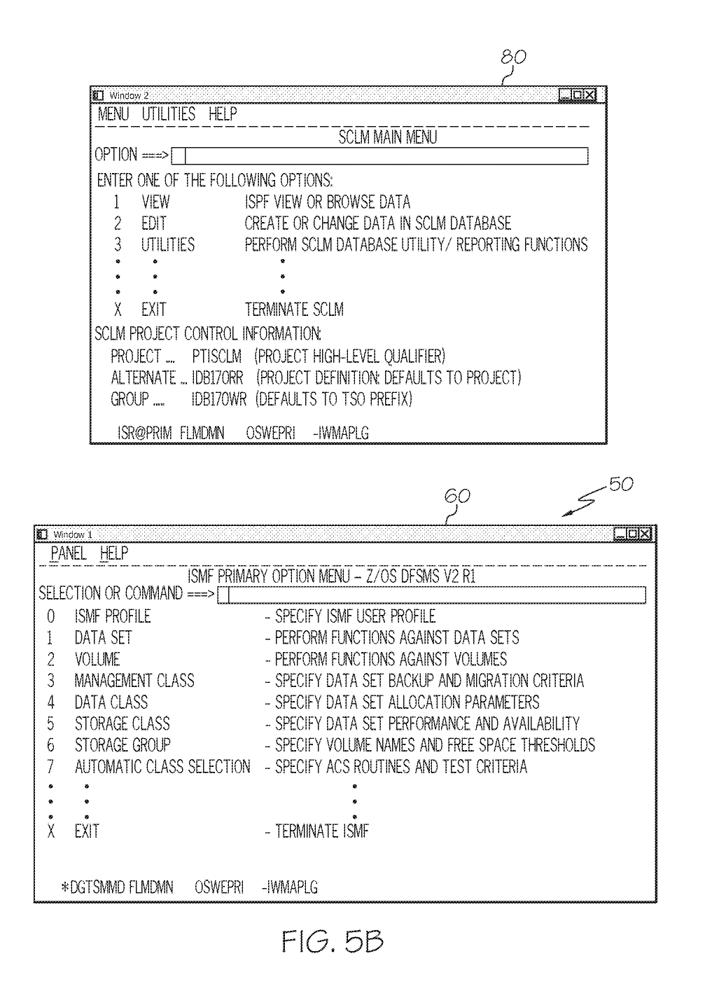

In a more detailed example, FIG. 5A illustrates how a selected one of the ISPF windows 60, 80 can be re-sized independently of the other of the ISPF windows 60, 80. Particularly, by using a mouse or by entering a predefined re-sizing command into the command entry field 82 of ISPF window 80, a user at terminal 20 can control the ISPF window 80 to become smaller independently of the ISPF window 60. Conversely, the user at terminal 20 can perform a similar, but opposite, process to enlarge the size of the ISPF window 80 independently of the ISPF window 60. Thus, the user can modify the window size of ISPF window 80 without modifying the size of the other ISPF window 60. Conventionally, this particular function was not possible as the ISPF panels output to the so-called split-screen were not resizable, let alone independently resizable by a user.

FIG. 5B illustrates another function of the present embodiments in which each ISPF window 60, 80 is also independently movable around the emulator 50. The particular method by which the ISPF windows are moved around the emulator 50 screen is immaterial; however, according to one embodiment of the present disclosure, the user can use a mouse to “grab” a selected ISPF window, such as ISPF window 80, and “drag” that ISPF window 80 to a new position within the emulator 50. In the embodiment of FIG. 5B, ISPF window 80 and ISPF window 60 have switched positions.

In addition to the ISPF windows 60, 80 being independently sizable and movable, embodiments of the present disclosure also allow a user to enter other application-independent commands mapped to other hot-keys, and utilize those application-independent commands to control one or more other ISPF windows 60, 80, even when the other ISPF windows 80 do not have focus.

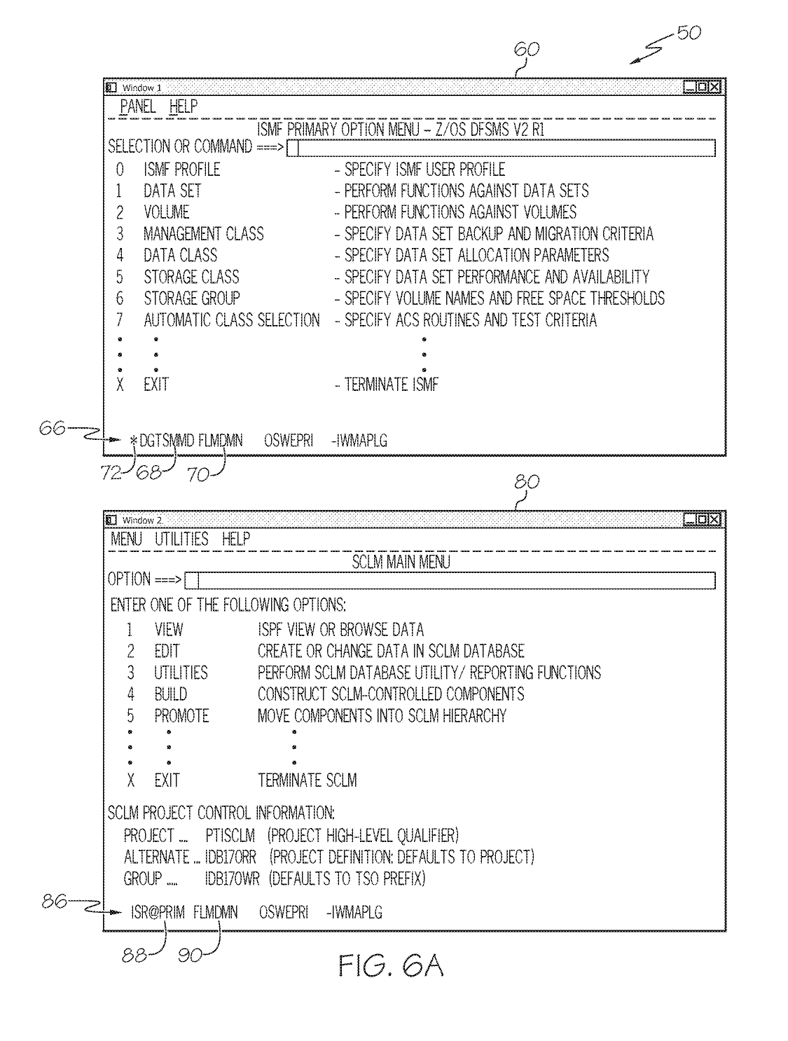

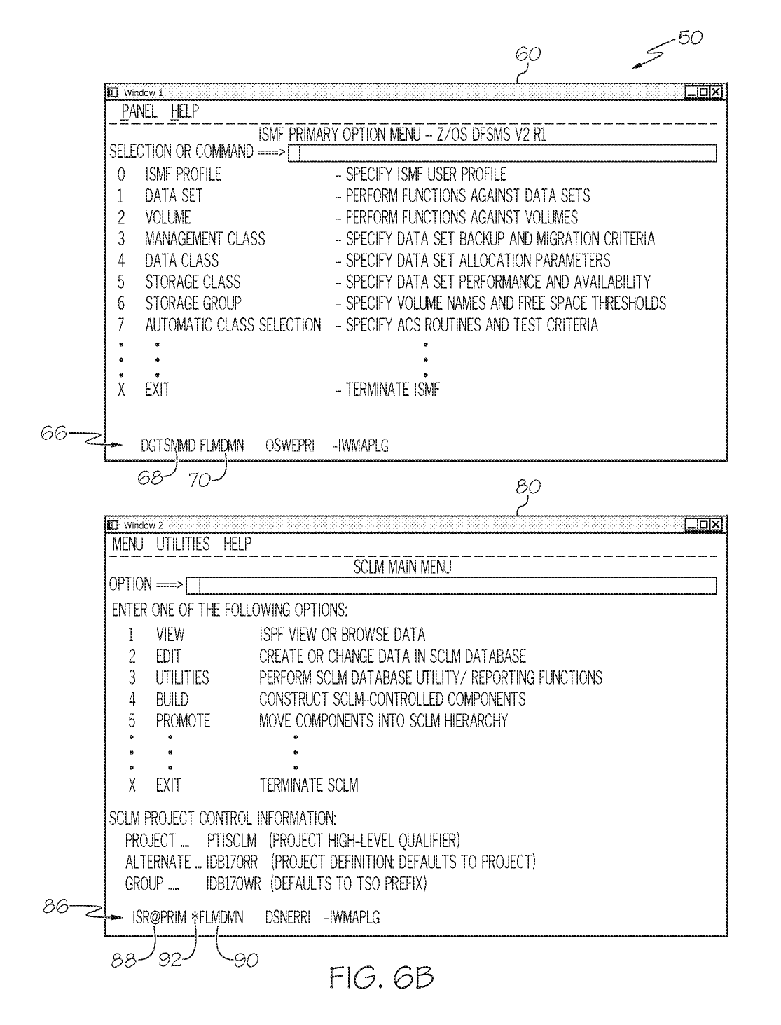

FIG. 6A, for example, illustrates the independent ISPF windows 60, 80 according to one embodiment of the present disclosure. As seen in FIG. 6A, the focus indicator 72 identifies ISPF window 72 as currently having focus. Thus, in a process that is described later in more detail, a control application executing at the terminal 20 will route the data between the ISPF window 60 and its corresponding application program executing on mainframe 40. When a user at terminal 20 inputs an application-independent command (e.g., REFRESH), by pressing a pre-defined or pre-programmed “hot-key,” for example, the control application translates that application-independent REFRESH command into a plurality of application-specific REFRESH commands for the respective application programs at mainframe 40, and issues those application-specific REFRESH commands to those application programs. In response, each of the application programs will send a copy of their latest data to the control application, which then matches the received information to the appropriate ISPF window 60, 80, and uses that information to refresh the corresponding ISPF window 60, 80.

FIG. 6B illustrates another embodiment of the present disclosure in which the control application of the present disclosure processes a different application-independent command—i.e., a SWITCH FOCUS command. In this case, the user could depress a hot-key mapped to a SWITCH FOCUS command for a specific ISPF window. Thus, in at least one embodiment, each ISPF window is mapped to its own SWITCH FOCUS hot-key or combination of keys. Upon receiving the SWITCH FOCUS command, the control application could translate that command into an application-specific command that is understood by the application associated with ISPF window 80 (i.e., the ISPF window associated with the particular hot-key that was depressed), and then send that command to that application. The application would then send a copy of its latest data to the control application, which would then route that information to ISPF window 80. This would, in effect, “repaint” the ISPF panel associated with ISPF window 80 such that ISPF window 80 displays the most up-to-date data. Additionally, the focus indicator 72, 92 would be moved proximate the identifier 70, 90 to indicate that ISPF window 80 now has the current focus.

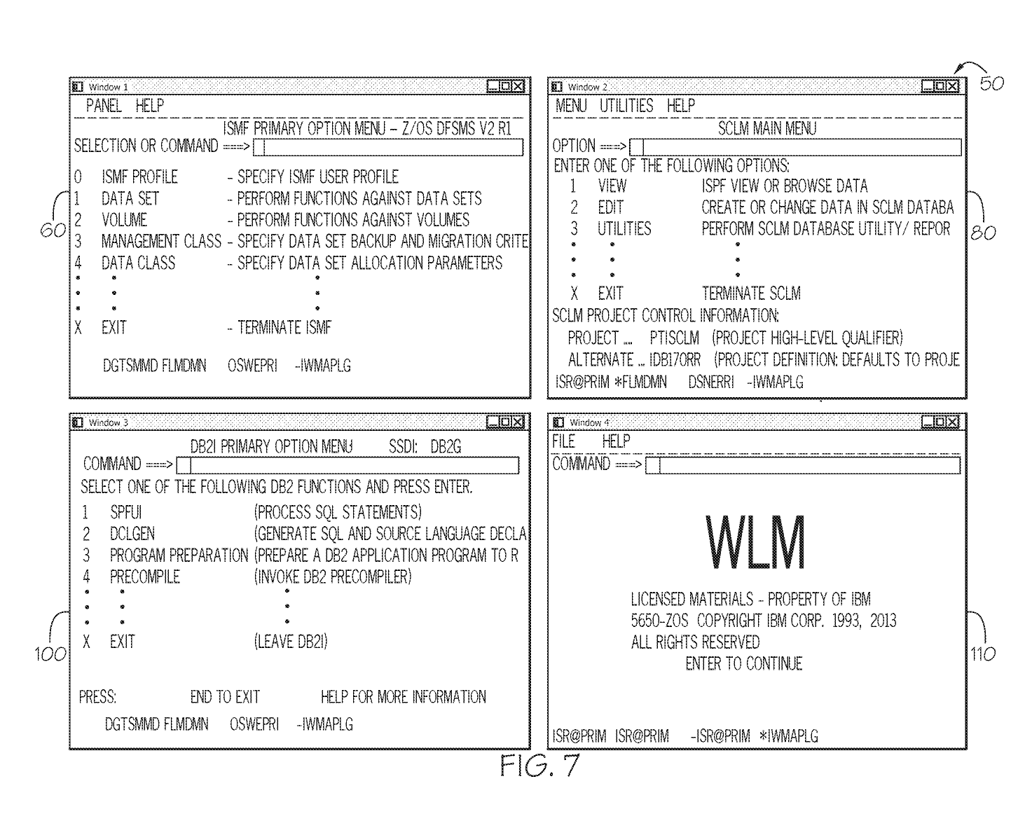

The previously described embodiments are discussed relative to the present disclosure operating with just two ISPF windows 60, 80. However, those of ordinary skill in the art will readily appreciate that this is for mere ease of discussion. Embodiments of the present disclosure can easily handle more than two ISPF windows 60, 80 as needed or desired. FIG. 7 is one example wherein the present disclosure generates and outputs four ISPF windows 60, 80, 100, and 110 to the single emulator 50 under a single user login. As above, each ISPF window 60, 80, 100, 110 is an independent graphical user interface (GUI) containing the content of an ISPF panel corresponding to an application program executing on mainframe 40. Each of the ISPF windows 60, 80, 100, 110 is independently sizable and movable, as previously described. Further, as described previously, users can control the functionality of one or more selected ISPF windows 60, 80, 100, 110 and their corresponding application programs merely by depressing a predefined hot-key or combination of keys. Such commands include, but are not limited to, the REFRESH and SWITCH FOCUS commands previously described, as well as a CLOSE command which will close a specified window responsive to detecting the user depressing a corresponding hot-key.

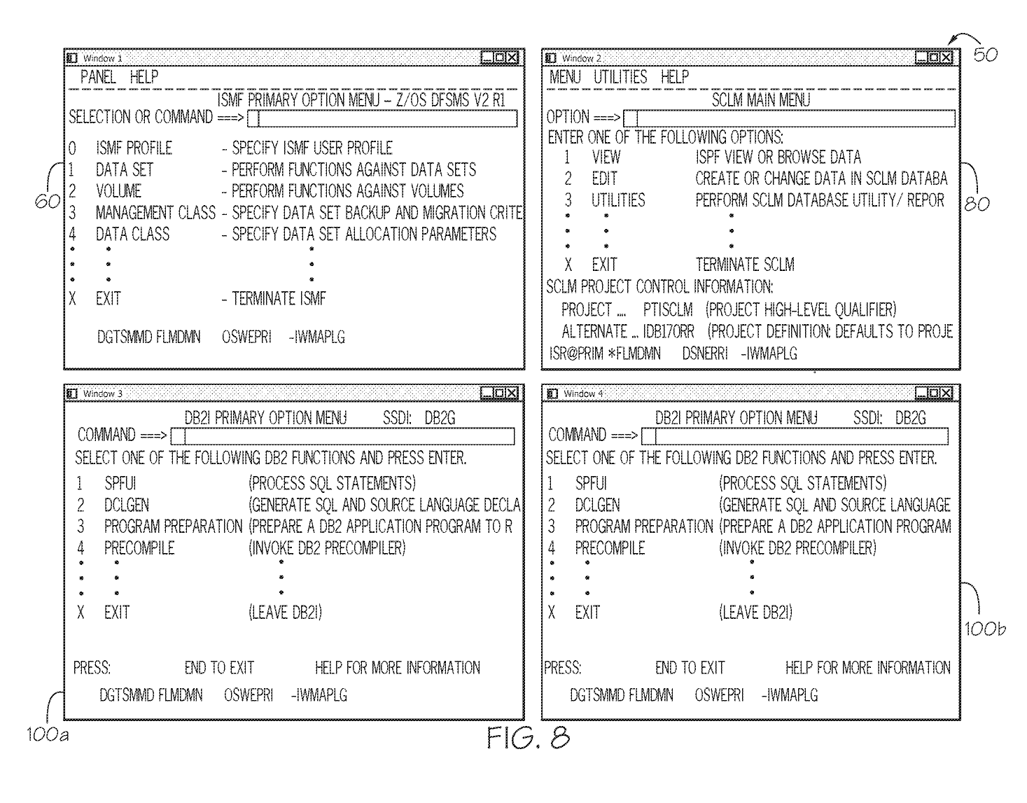

FIG. 8 illustrates another embodiment in which a user can create a “clone” ISPF window from a selected ISPF window. For example, as seen in FIG. 8, emulator 50 has four ISPF windows, although any number of ISPF windows is possible. The ISPF windows 60, 80, 100a, are all respectively associated with a different application program executing on mainframe 40. In some instances, a user may wish to have a second (or third, etc.) ISPF window that is the same as another ISPF window already being output. The present embodiments provide this capability.

More specifically, a user can depress a hot-key, or a combination of keys, mapped to an application-independent CLONE command to make a clone or copy of a selected ISPF window. The selected ISPF window may be, for example, whichever ISPF window has the current focus (e.g., ISPF window 100a) when the hot-key is depressed. As above, depressing the predefined key causes the generation of an application-independent CLONE command. Upon receiving the CLONE command, the control application generates the commands that are necessary for duplicating ISPF window 100a into a newly cloned ISPF window 100b. This may entail, for example, translating the application-independent CLONE command into an application-specific CLONE command that is understood by the application associated with the ISPF window 100a being cloned, and sending that application-specific CLONE command to that application. The control application would then generate the commands to create the cloned ISPF window 100b, and output that cloned ISPF window 100b to emulator 50. Data received from the application associated with the ISPF window 100a would then be received at the control application, and routed to both ISPF windows 100a, 100b.

In the embodiment shown in FIG. 8, the cloned window 100b is output to the same display as the other ISPF windows 60, 80, 100a. However, the present disclosure is not so limited. In one embodiment, the control application is configured to receive a device identifier as a parameter with the application-independent clone command when the user depresses a predefined hot-key. The device identifier may be associated with the particular hot-key that was depressed, for example, but uniquely identifies an independent device, such as a display device or a projection device, for example. In these cases, the control application would still route the data to both the ISPF windows 100a,100b, but would do so by specifically routing the data for the cloned ISPF window 100b to the device identified by the device identifier parameter received with the application-independent CLONE command.

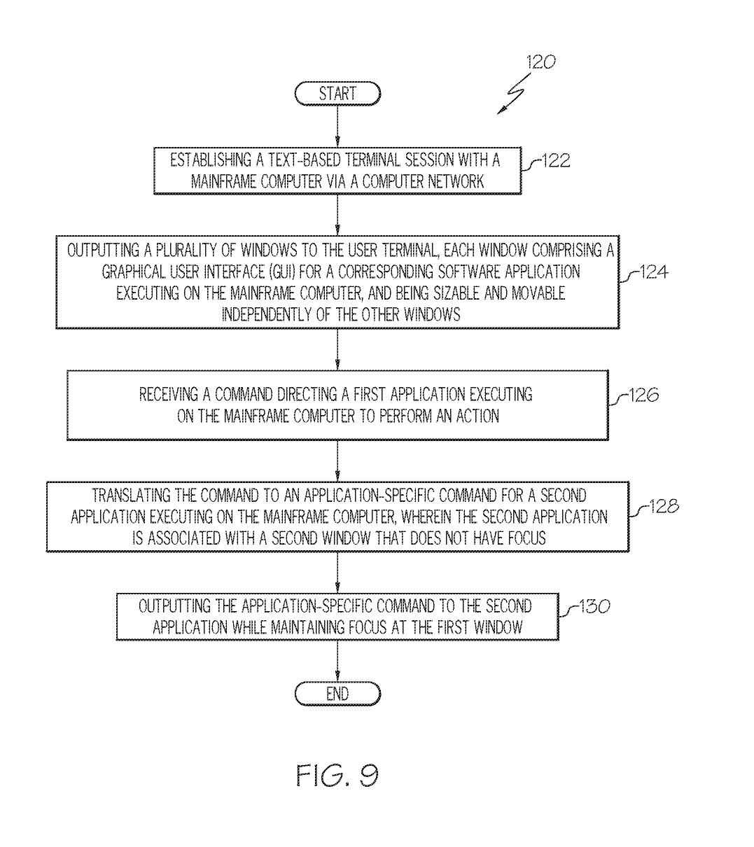

FIG. 9 is a flow chart for a method 120 of managing a plurality of ISPF windows output to a single emulator instance 50 at a user terminal 20 according to an embodiment of the present disclosure. Method 120 is implemented by a control application executing at user terminal 20.

Method 120 begins with the establishment of a text-based terminal session 14 (e.g., a Telnet session) with mainframe 40 (box 122). The text-based terminal session 14 allows the communication of text data between the user terminal 20 and the plurality of applications executing on mainframe 40. Once the text-based terminal session has been established, the user can logon to mainframe 40 and initiate an ISPF session, as previously described.

Initiating the ISPF session causes the control application at terminal 20 to output a first ISPF panel containing the data associated with the ISPF application as an ISPF window 60. The user can then subsequently instantiate additional ISPF windows for corresponding applications executing at mainframe 40, by entering, for example, command options into the command entry field 62 of ISPF 60. Each ISPF window functions as a graphical user interface (GUI) for the corresponding application executing at mainframe 40 (box 124).

For example, the ISPF window 60 may comprise the ISMF Primary Option Menu seen in FIG. 4. The user can enter one of the command options (e.g., ‘0’, ‘1’, ‘2’, ‘3’, etc.) into the command entry field 62. Upon receipt of the command option, the control application connects to the application that corresponds to the command option, and receives data from that application for display to the user. The control application then generates an ISPF window, associates that ISPF window with the application (e.g., a mapping), and outputs the information (i.e., the ISPF panel associated with the application) as an ISPF window, such as ISPF window 80, that is sizable and movable independently of all other ISPF windows.

Only one of the plurality of ISPF windows being displayed to the user on terminal 20 will have focus. Therefore, the user may enter commands into the command entry field of that ISPF window to cause the corresponding application program executing at mainframe 40 to perform an action. However, according to the present disclosure, these commands may also be used to control the other applications executing on mainframe 40 to perform the same or similar action, even though the ISPF windows associated with those application programs do not currently have focus.

Thus, as seen in method 120, the control application executing at terminal 20 may receive a command that is associated with a particular application-independent command. The command, when issued to the corresponding application program, will cause that application program to perform a predefined, corresponding action (box 126). Upon receiving the command, the control application at terminal 20 also translates the command into one or more application specific commands—each of which is configured to cause a different one of the application programs executing on mainframe 40 to perform the same or similar action (box 128). Once the command has been translated, the control application outputs the translated application-specific commands to their corresponding application programs to be executed by those application programs (box 130).

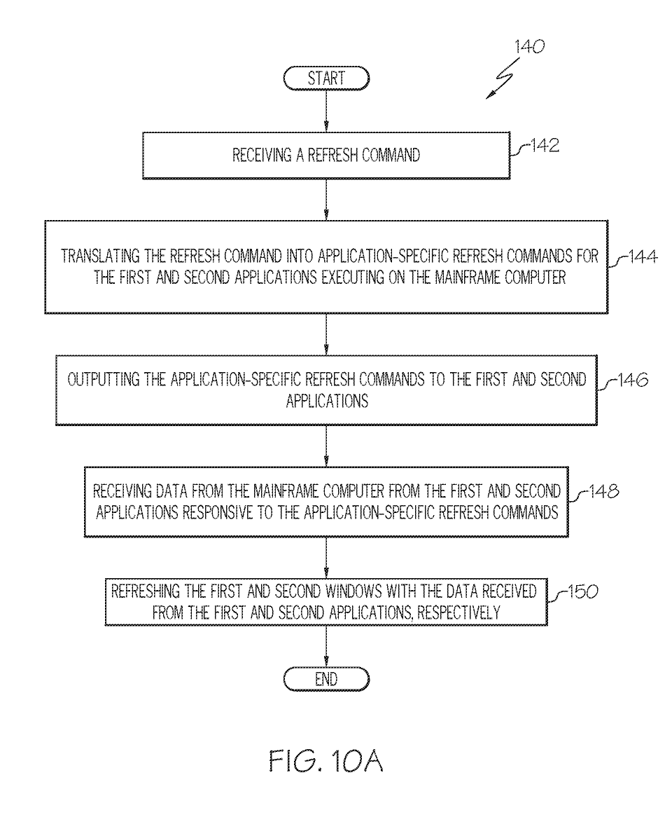

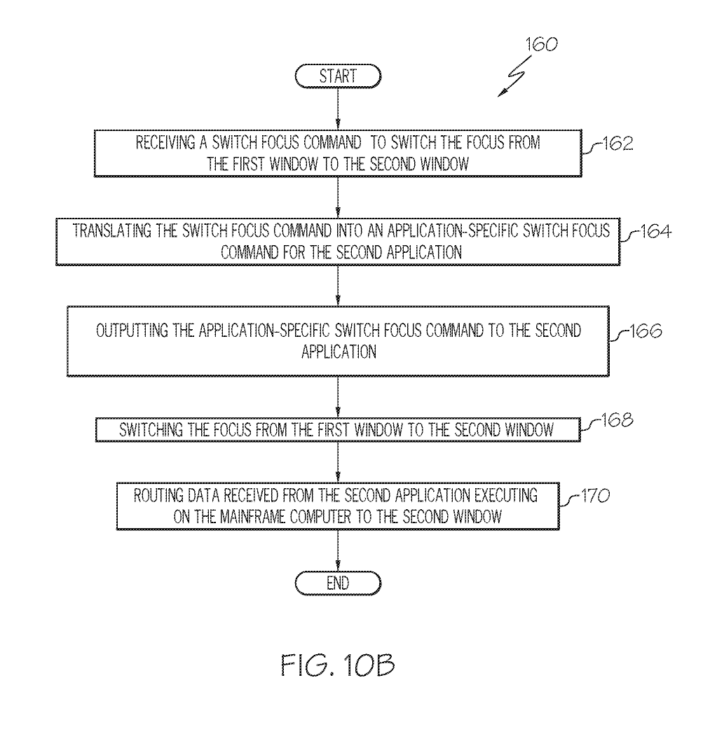

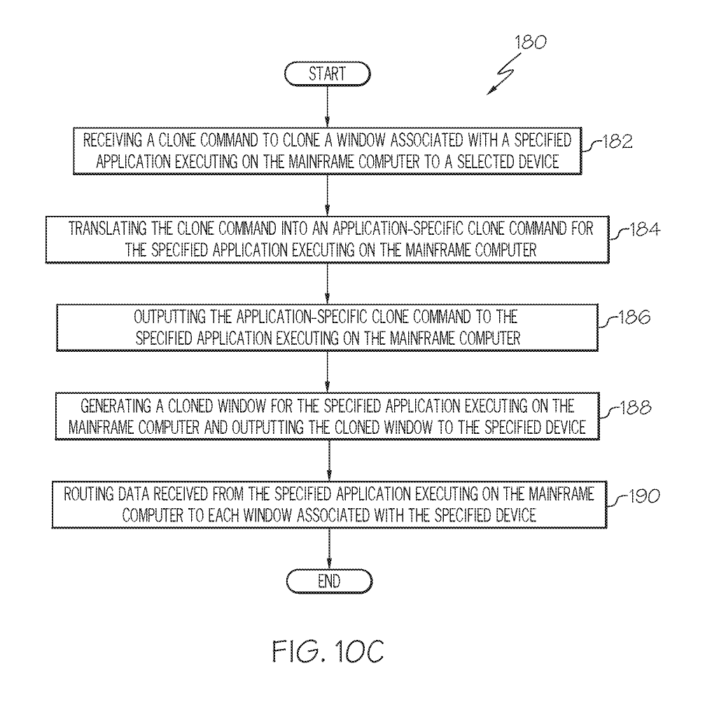

FIG. 10A is a flow chart illustrating a method 140 for processing one such command—i.e., a REFRESH command—according to the present disclosure. As above, method 140 is performed by the control application executing at user terminal 20.

Method 120 begins with the control application receiving a REFRESH command when a user depresses a hot-key that is mapped to the REFRESH command (box 142). The REFRESH command in this embodiment is an application-independent command that may be used to perform a REFRESH function at the first ISPF window, as well as at one or more other ISPF windows at terminal 20. Responsive to receiving the REFRESH command, the control application recognizes the command as an application-independent command, and translates the REFRESH command into one or more application-specific REFRESH commands (box 144). The application-specific commands are then output by the control application to each of the corresponding application programs executing at the mainframe 40 (box 146). In response, each application program at the mainframe 40 that received an application-specific command responds to the control application with the latest set of data (box 148). The control application then uses the received data to refresh each ISPF window. Specifically, each ISPF window that is being output to the terminal 20 is refreshed using data from its corresponding application program (box 150).

FIG. 10B is a flow chart illustrating a method 160 in which the user enters a SWITCH FOCUS command to cause the control application to switch the focus from a first ISPF window to a second ISPF window. As above, method 160 is implemented at the user terminal 20.

Method 160 begins with the control application receiving a SWITCH FOCUS command when the user depresses a hot-key corresponding to the SWITCH FOCUS command (box 162). The SWITCH FOCUS command, as above, is an application-independent command and may be particularly mapped to the second ISPF window that will gain focus. Responsive to receiving the SWITCH FOCUS command, the control application recognizes the command as an application-independent command, and translates the SWITCH FOCUS command into an application-specific SWITCH FOCUS command for the application that corresponds to the second ISPF window (box 164). The application-specific SWITCH FOCUS command is then output by the control application to the application program corresponding to the second ISPF window (box 166). The control application also generates the command necessary to cause the focus to switch from the first ISPF window to the second ISPF window (box 168). The control application then receives the latest set of data from the second application executing on the mainframe 40, and sends that data to the second ISPF window to refresh the second ISPF window (box 170).

FIG. 10C is a flow diagram illustrating a method 180 for cloning a selected ISPF window. Method 180 is implemented at the terminal 20 and begins with the control application receiving a CLONE command responsive to the user depressing a hot-key corresponding to the CLONE command (box 182). While the CLONE command may be received while an ISPF window currently has focus, it need not specify that particular ISPF window for cloning. Specifically, in one embodiment, the user may depress a hot-key associated with the CLONE command for an ISPF window that does not have the current focus. Regardless, embodiments of the present disclosure can generate such cloned windows and output those cloned windows to any specified device identified by the user.

Upon receiving the CLONE command, the control application translates the CLONE command, which is an application-independent command, into an application-specific CLONE command for the application corresponding to the ISPF window being cloned (box 184). The control application then outputs the application-specific command to the application program (box 186), generates the cloned ISPF window, and outputs the cloned ISPF window to the device specified by the user (box 188). Note that absent a specific mention of a particular device for the cloned ISPF window by the user, the control application will output the cloned ISPF window to the terminal 20 having focus. Thereafter, whenever the control application receives data for the window being cloned, control application will output that data to both the ISPF window being cloned, and the cloned ISPF window (box 190).

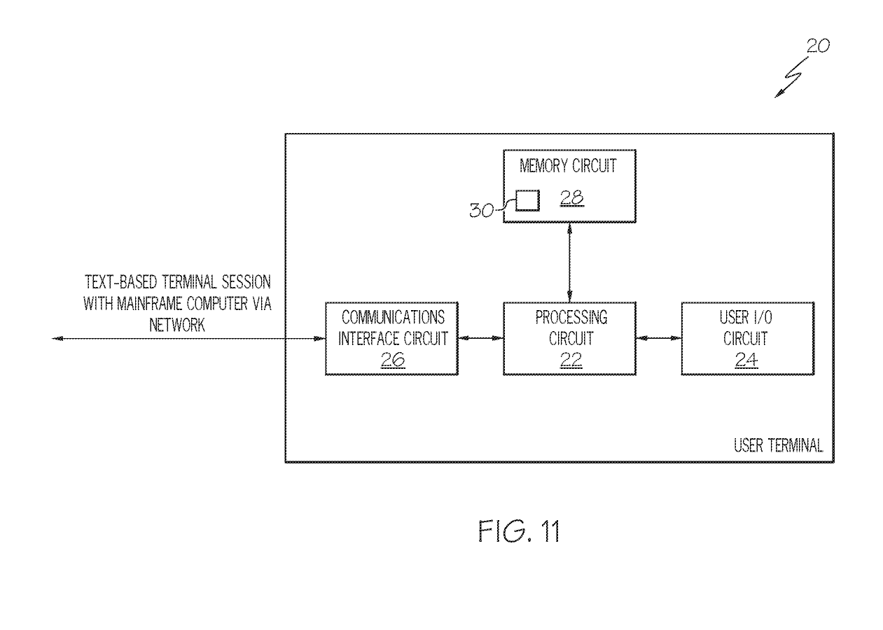

FIG. 11 is a functional block diagram of a user terminal, such as terminal 20, configured to perform the embodiments of the present disclosure. As seen in FIG. 11, user terminal 20 comprises, inter alia, a processing circuit 22, a user Input/Output (I/O) circuit 26, a communications circuit 28, and a memory circuit 28. The memory circuit 28, as described in more detail later, is configured to store the control application 30. Those skilled in the art will readily appreciate that terminal 20 is not limited solely to the components seen in the figure, but rather, may comprise other hardware and/or software components as needed or desired.

Processing circuit 22 may be implemented by circuitry comprising one or more microprocessors, hardware, firmware, or a combination thereof. Generally, processing circuit 22 controls the operation and functions of terminal 20 according to appropriate standards. Such operations and functions include, but are not limited to, communicating with mainframe 40 via network 12. Additionally, according to various embodiments of the present disclosure, processing circuit 22 is configured to generate and manage multiple ISPF windows under the umbrella of a single user login, as previously described.

The user I/O interface circuit 24 comprises the components necessary for a user to interact with terminal 20. Such components include, but are not limited to, a display device that displays the plurality of ISPF windows, a keyboard, a mouse, and any other input/output mechanisms or devices that facilitate the user's ability to interact with terminal 20 according to embodiments of the present disclosure.

The communications interface circuit 26 may comprise, for example, an I/O card or other interface circuit configured to communicate data and information with mainframe 40 via network 12. As those of ordinary skill in the art will readily appreciate, the communications interface circuit 28 may communicate with these and other entities using any known protocol needed or desired. In one embodiment, however, communications interface circuit 26 sends data to and receives data from mainframe 40 via network 12 in data packets according to the well-known ETHERNET protocol. In this regard, communications interface circuit 26 may comprise an ETHERNET card, but may also comprise circuitry capable of wireless communications such as over WiFi, for example.

Memory 28 may comprise any non-transitory, solid state memory or computer readable storage media known in the art. Suitable examples of such media include, but are not limited to, ROM, DRAM, Flash, or a device capable of reading computer-readable storage media, such as optical or magnetic storage media. Memory circuit 28 stores programs and instructions, such as the control application 30 that, when executed by processing circuit 22, causes the terminal 20 to generate a plurality of ISPF windows, associate each ISPF window with a corresponding application executing at the mainframe 40, and output each ISPF window to terminal 20. Additionally, as described above, the control application 30 routes data from the corresponding application programs executing on mainframe 40 to their respective ISPF windows, and translates application-independent commands into application-specific commands or execution by the specific application.

The present embodiments may, of course, be carried out in other ways than those specifically set forth herein without departing from essential characteristics of the disclosure. For example, it should be noted that the flowchart and block diagrams in the Figures illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, to blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

Thus, the foregoing description and the accompanying drawings represent non-limiting examples of the methods and apparatus taught herein. As such, the present invention is not limited by the foregoing description and accompanying drawings. Instead, the present invention is limited only by the following claims and their legal equivalents.

What is claimed is:

1. A computer-implemented method comprising:
establishing, by a user terminal, a text-based terminal session with a mainframe computer via a computer network, wherein the text-based terminal session is associated with a single user login;
outputting a plurality of windows to the user terminal, wherein each window comprises a graphical user interface (GUI) for a corresponding software application executing on the mainframe computer, and is sizable and movable independently of the other windows;
receiving, by the user terminal, a command directing a first application executing on the mainframe computer to perform an action;
translating the command to an application-specific command for a second application executing on the mainframe computer, wherein the second application is associated with a second window that does not have focus; and
outputting the application-specific command to the second application while maintaining focus at the first window.

2. The computer-implemented method of claim 1 wherein the GUI of each window comprises an interactive System Productivity Facility (ISPF) panel that is associated with a different corresponding software application executing on the mainframe computer.

3. The computer-implemented method of claim 1 further comprising:
receiving, at the user terminal, data from one of the first and second applications executing on the mainframe;
determining which of the first and second windows currently has the focus; and
outputting the data to whichever one of the first and second windows currently has the focus.

4. The computer-implemented method of claim 3 wherein determining which of the and second windows currently has the focus comprises:
reading a line of text displayed in one of the first and second windows, wherein the line of text comprises:
first and second application identifiers respectively identifying the first and second application programs executing on the mainframe computer; and
an active window indicator that identifies which of the first and second windows has the current focus;
determining that the first window currently has the focus if the active window indicator is proximate the first application identifier; and
determining that the second window currently has the focus if the active window indicator is proximate the second application identifier.

5. The computer-implemented method of claim 1 wherein outputting a plurality of windows to the user terminal comprises outputting the plurality of windows to a single emulator window.

6. The computer-implemented method of claim 1 wherein the command comprises an application independent command, and further comprising:
translating the command to an application-specific command for the first application; and
outputting the application-specific command for the first application to the first application.

7. The computer-implemented method of claim 6 wherein the application independent command comprises one of:
a refresh command to refresh the data displayed in the first and second windows;
a close command configured to close one or both of the first and second windows; and
a switch focus command to switch the focus from the first window to the second window.

8. The computer-implemented method of claim 1 wherein the command comprises an application-independent clone command to clone the first window at a specified device, the method further comprising:
translating the application-independent clone command to an application-specific clone command for the first application;
outputting the application-specific clone command to the first application;
generating a cloned first window;
outputting the cloned first window to the specified device; and
routing data received from the first application to both the first window and the cloned first window.

9. The computer-implemented method of claim 1 wherein the command comprises an application-independent clone command to clone the second window at a specified device, the method further comprising:
translating the application-independent clone command to an application-specific clone command for the second application;
outputting the application-specific clone command to the second application;
generating a cloned second window;
outputting the cloned second window to the specified device; and
routing data received from the second application to both the second window and the cloned second window.

10. A user terminal comprising:
a communications interface circuit configured to communicate data with a mainframe computer via a text-based terminal session; and
a processing circuit operatively connected to the communications network and configured to:
generate a plurality of interactive System Productivity Facility (ISPF) windows, wherein each window is independently sizable and movable relative to the other ISPF windows, and corresponds to a software application executing on the mainframe computer;
output the plurality of ISPF windows to a single emulator instance executing at the user terminal;
translate a received command to an application-specific command for a second application associated with a second ISPF window, wherein the first ISPF window has focus and the second ISPF window lacks focus; and
output the application-specific command to the second application while maintaining the focus at the first window.

11. The user terminal of claim 10 wherein each ISPF window comprises an ISPF panel associated with a different corresponding application executing on the mainframe computer.

12. The user terminal of claim 10 wherein the processing circuit is further configured to:
receive, at the user terminal, data from one of the first and second applications executing on the mainframe;
determine which of the first and second ISPF windows currently has the focus; and
output the data to whichever one of the first and second ISPF windows currently has the focus.

13. The user terminal of claim 12 wherein to determine which of the first and second ISPF windows currently has the focus, the processing circuit is configured to:
read a line of text displayed in one of the first and second ISPF windows, wherein the line of text comprises:
first and second application identifiers respectively identifying the first and second application programs executing on the mainframe computer; and
a focus indicator that identifies which of the first and second ISPF windows currently has focus;
determine that the first ISPF window currently has the focus if the focus indicator is proximate the first application identifier; and
determine that the second ISPF window currently has the focus if the focus indicator is proximate the second application identifier.

14. The user terminal of claim 10 wherein the command comprises an application independent command, and wherein the processing circuit is further configured to:
translate the command to an application-specific command for the first application; and
output the application-specific command for the first application to the first application.

15. The user terminal of claim 14 wherein the application independent command comprises one of:
a refresh command to refresh the data displayed in the first and second windows;
a close command to close one or both of the first and second windows; and
a switch focus command to switch the focus from the first window to the second window.

16. The user terminal of claim 10 wherein the command comprises an application-independent clone command to clone the first window at a specified device, and wherein the processing circuit is further configured to:
translate the command to clone the first ISPF window to an application-specific clone command for the first application;
output the application-specific clone command to the first application;
generate a cloned first ISPF window;
output the cloned first ISPF window to the specified device; and
route data received from the first application to both the first ISPF window and the cloned first ISPF window.

17. The user terminal of claim 14 wherein the command comprises an application-independent clone command to clone the second ISPF window at a specified device, and wherein the processing circuit is further configured to:
translate the command to clone the second ISPF window to an application-specific clone command for the second application;
output the application-specific clone command to the second application;
generate a cloned second ISPF window;
output the cloned second ISPF window to the specified device; and
route data received from the second application to both the second ISPF window and the cloned second ISPF window.

18. A computer-readable storage medium having computer code stored thereon that, when executed by a processing circuit of a user terminal communicatively connected to a mainframe computer via a text-based session, causes the processing circuit to:
establish a text-based terminal session with a mainframe computer via a computer network;
output a plurality of windows to the user terminal, wherein each window comprises a graphical user interface (GUI) for a corresponding software application executing on the mainframe computer, and is sizable and movable independently of the other windows;
receive a command that directs a first application executing on the mainframe computer to perform an action;
translate the command to an application-specific command for a second application executing on the mainframe computer, wherein the second application is associated with a second window that does not have focus; and
output the application-specific command to the second application while maintaining focus at the first window.
